(19) United States
(12) Patent Application Publication
(10) Pub. No.: US 2012/0134534 A1
(43) Pub. Date: May 31, 2012

(54) CONTROL COMPUTER AND SECURITY MONITORING METHOD USING THE SAME

(75) Inventors: DA-LONG LEE, Tu-Cheng (TW); CHIEN-FA YEH, Tu-Cheng (TW); CHUNG-I LEE, Tu-Cheng (TW)

(73) Assignee: HON HAI PRECISION INDUSTRY CO., LTD., Tu-Cheng (TW)

(21) Appl. No.: 13/155,311

(22) Filed: Jun. 7, 2011

(30) Foreign Application Priority Data
Nov. 25, 2010 (TW) 99140692

(51) Int. Cl. G06K 9/00

(52) U.S. Cl. 382/103

(57) ABSTRACT

A method for performing security surveillance using a control computer sends an image obtaining request from the control computer to a preset channel of a network video recorder (NVR) or a digital video recorder (DVR), and receives captured images from the preset channel of the NVR or the DVR. The method further detects a specified object in the captured images, and stores/outputs an image area of the specified object in a storage device of the control computer or a terminal device.

### BACKGROUND

1. Technical Field

Embodiments of the present disclosure relate to monitoring technology, and more particularly to a control computer and security monitoring method using the control computer.

2. Description of Related Art

Network video recorders (NVRs) or digital video recorders (DVRs) have been used to perform security surveillance by detecting a specified object (e.g., a moving object) using a hardware chip installed in the NVRs or the DVRs. However, the NVR or the DVR detects the specified object from captured images of all of channels of the NVR or the DVR, which may increase workload of the hardware chip of the NVR or the DVR. On the other hand, an accuracy rate of detecting the specified object using the hardware chip is unsatisfactory. Therefore, a more efficient method for performing security surveillance using the NVR or DVR is desired.

### BRIEF DESCRIPTION OF THE DRAWINGS

FIG. 1 is a schematic diagram of one embodiment of a control computer in communication with a plurality of network video recorders and digital video recorders.

FIG. 2 is a block diagram of one embodiment of the control computer.

FIG. 3 is a block diagram of one embodiment of a security monitoring system in control computer.

FIG. 4 is a flowchart of one embodiment of a method for performing security surveillance using the control computer.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

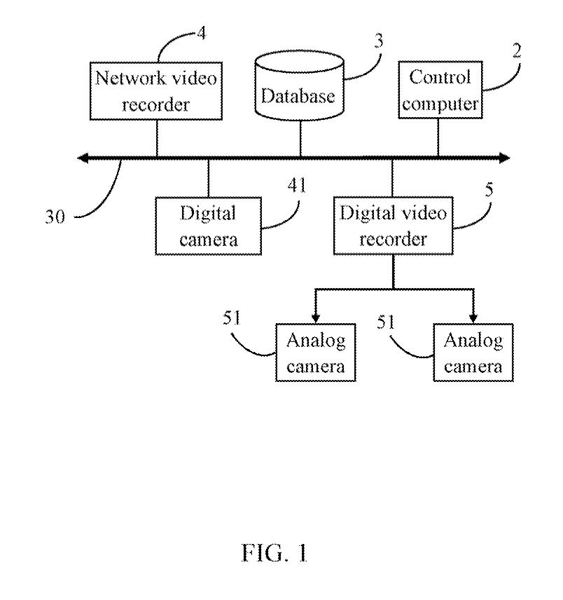

FIG. 1 is a schematic diagram of one embodiment of a control computer 2 in communication with a plurality of network video recorders (NVRs) 4 and digital video recorders (DVRs) 5 through a network 30. For simplification, a NVR 4 and a DVR 5 is shown as an example in FIG. 1. Further, the control computer 2 is connected to a database 3 through the network 30. The network 30 may be the Internet, the Intranet, or any other suitable network.

In one embodiment, the NVR 4 is used to obtain images captured by a plurality of digital cameras 41, and the DVR 5 is used to obtain images captured by a plurality of analog cameras 51. In other embodiments, the NVR 4 also can obtain the images from the analog cameras 51 through the DVR 5. The control computer 2 is used to receive the obtained images from the NVR 4 and the DVR 5, and detect a specified object (e.g., a moving object) in the obtained images. The database 3 is used to store monitor parameters, such as an Internet Protocol (IP) address of the NVR 4 or the DVR 5.

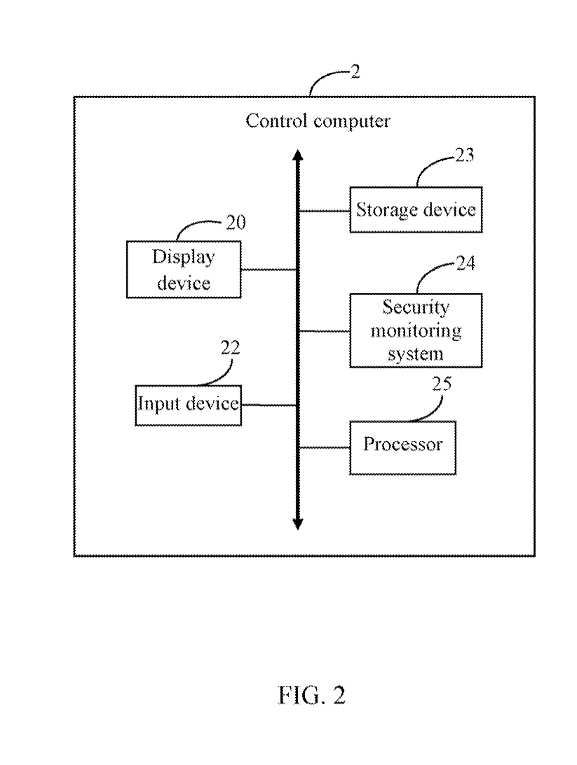

FIG. 2 is a block diagram of one embodiment of the control computer 2. In one embodiment, the control computer 2 includes a display device 20, an input device 22, a storage device 23, a security monitoring system 24, and at least one processor 25. The security monitoring system 24 may be used to detect the specified object in the obtained images of the NVR 4 or the DVR 5 according to a preset channel of the NVR 4 or the DVR 5.

The display device 20 may be used to display images obtained by the NVR 4 or the DVR 5, and the input device 22 may be a mouse or a keyboard used to input computer readable data.

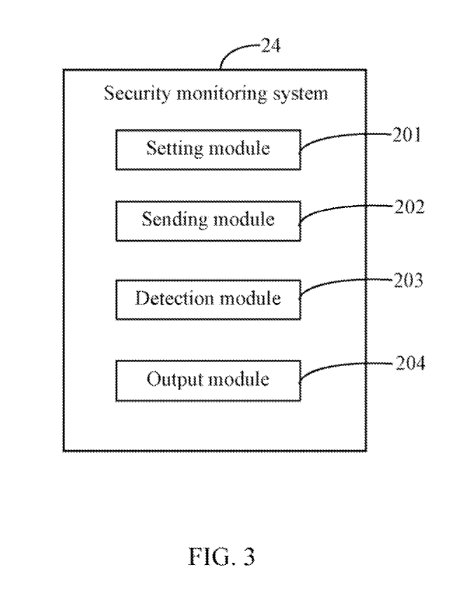

FIG. 3 is a block diagram of one embodiment of the security monitoring system 24 in the control computer 2. In one embodiment, the security monitoring system 24 may include one or more modules, for example, a setting module 201, a sending module 202, a detection module 203, and an output module 204. The one or more modules 201-204 may comprise computerized code in the form of one or more programs that are stored in the storage device 23 (or memory). The computerized code includes instructions that are executed by the at least one processor 25 to provide functions for the one or more modules 201-204.

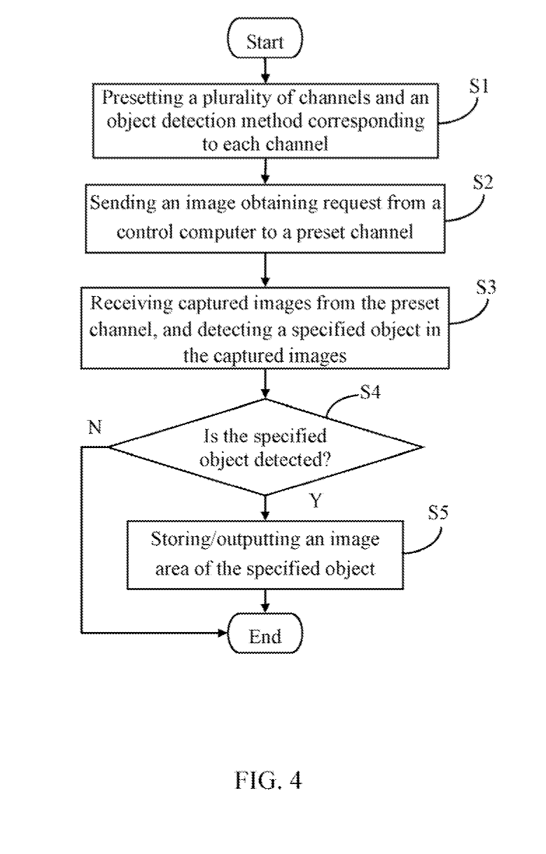

FIG. 4 is a flowchart of one embodiment of a method for performing security surveillance using the control computer 2. Depending on the embodiment, additional blocks may be added, others removed, and the ordering of the blocks may be changed.

In block S1, the setting module 201 presets a plurality of channels of the plurality of NVRs or DVRs, and presets an object detection method corresponding to each of the channels of the NVRs or the DVRs. The setting module 201 stores the settings in the storage device 23 of the control computer 2. In one embodiment, the object detection method may include, but is not limited to, a human face detection method, a license plate detection method, and a moving object detection method.

In block S2, the sending module 202 sends an image obtaining request from the control computer 2 to a preset channel of one of the NVRs (e.g., the NVR 4) or DVRs (e.g., the DVR 5). The NVR 4 or DVR 5 sends captured images to the control computer 2 through the network 30.

In block S3, the detection module 203 receives the captured images from the preset channel of the NVR 4 or the DVR 5, and detects a specified object in the captured images according to a preset object detection method of the preset channel. In one embodiment, the specified object may include, but is not limited to, the human face, the license plate, and the moving object. For example, if the preset object detection method of the preset channel is the human face detection method, the detection module 203 detects the human face in the captured images.

In block S4, the detection module 203 determines if the specified object is detected. If the specified object is detected, the procedure goes to block S5. If the specified object is not detected, the procedure ends.

In block S5, the output module 204 stores/outputs an image area of the specified object in the storage device 23 or a terminal device (e.g., a mobile phone). For example, the output module 204 stores the image area of the specified object in the storage device 23 of the control computer 2, or sends the image area of the specified object to the terminal device using an electronic mail or a multimedia messaging service (MMS) message.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A security monitoring method, the method comprising:
sending an image obtaining request from a control computer to a preset channel of a network video recorder (NVR) or a digital video recorder (DVR);
receiving captured images from the preset channel of the NVR or the DVR, and detecting a specified object in the captured images according to a preset object detection method of the preset channel; and
storing/outputting an image area of the specified object in a storage device of the control computer or a terminal device.

2. The method according to claim 1, wherein the preset object detection method includes a human face detection method, a license plate detection method, or a moving object detection method.

3. The method according to claim 2, wherein the specified object is a human face, a license plate, or a moving object.

4. The method according to claim 1, wherein the step of storing/outputting the image area of the specified object in a storage device or a terminal device comprises:
storing the image area of the specified object in the storage device of the control computer; or
sending the image area of the specified object to the terminal device using an electronic mail or a multimedia messaging service (MMS) message.

5. The method according to claim 1, further comprising:
presetting a plurality of channels of the NVR or DVR, and presetting an object detection method corresponding to each of the plurality of channels of the NVR or the DVR; and
storing the settings in the storage device of the control computer.

6. A control computer, comprising:
a storage device;
at least one processor; and
one or more modules that are stored in the storage device and are executed by the at least one processor, the one or more modules comprising instructions:
to send an image obtaining request from a control computer to a preset channel of a network video recorder (NVR) or a digital video recorder (DVR);
to receive captured images from the preset channel of the NVR or the DVR, and detect a specified object in the captured images according to a preset object detection method of the preset channel; and
to store/output an image area of the specified object in a storage device of the control computer or a terminal device.

7. The control computer according to claim 6, wherein the preset object detection method includes a human face detection method, a license plate detection method, or a moving object detection method.

8. The control computer according to claim 7, wherein the specified object is a human face, a license plate, or a moving object.

9. The control computer according to claim 6, wherein the instruction of storing/outputting the image area of the specified object in a storage device or a terminal device comprises:
storing the image area of the specified object in the storage device of the control computer; or
sending the image area of the specified object to the terminal device using an electronic mail or a multimedia messaging service (MMS) message.

10. The control computer according to claim 6, wherein the one or more modules further comprise instruction: to preset a plurality of channels of the NVR or DVR and an object detection method corresponding to each of the plurality of channels of the NVR or the DVR, and store the settings in the storage device of the control computer.

11. A non-transitory storage medium having stored thereon instructions that, when executed by a processor of a control computer, causes the processor to perform a security monitoring method, the method comprising:
sending an image obtaining request from a control computer to a preset channel of a network video recorder (NVR) or a digital video recorder (DVR);
receiving captured images from the preset channel of the NVR or the DVR, and detecting a specified object in the captured images according to a preset object detection method of the preset channel; and
storing/outputting an image area of the specified object in a storage device of the control computer or a terminal device.

12. The non-transitory storage medium according to claim 11, wherein the preset object detection method includes a human face detection method, a license plate detection method, or a moving object detection method.

13. The non-transitory storage medium according to claim 12, wherein the specified object is a human face, a license plate, or a moving object.

14. The non-transitory storage medium according to claim 11, wherein the step of storing/outputting the image area of the specified object in a storage device or a terminal device comprises:
storing the image area of the specified object in the storage device of the control computer; or
sending the image area of the specified object to the terminal device using an electronic mail or a multimedia messaging service (MMS) message.

15. The non-transitory storage medium according to claim 11, wherein the method further comprises:
presetting a plurality of channels of the NVR or DVR, and presetting an object detection method corresponding to each of the plurality of channels of the NVR or the DVR; and
storing the settings in the storage device of the control computer.

16. The non-transitory storage medium according to claim 11, wherein the medium is selected from the group consisting of a hard disk drive, a compact disc, a digital video disc, and a tape drive.
